(19) United States
(12) Patent Application Publication
(10) Pub. No.: US 2017/0094913 A1
(43) Pub. Date: Apr. 6, 2017

(54) PLANT TIES

(71) Applicants: JAMES JOHN THORN, ROCHFORD (GB); OAKTHRIFT CORPORATION LTD, HERTFORDSHIRE (GB)

(72) Inventor: JAMES JOHN THORN, ROCHFORD (GB)

(21) Appl. No.: 15/125,472

(22) PCT Filed: Mar. 15, 2015
(86) PCT No.: PCT/GB2015/050742

§ 371 Date: Sep. 12, 2016

(30) Foreign Application Priority Data
Mar. 18, 2014 (GB) GB1404857.3

(51) Int. Cl. A01G 9/12

(52) U.S. Cl. CPC A01G 9/128; A01G 9/122

(57) ABSTRACT

A plant tie comprises a plastically deformable elongate body having first and second free ends that are attachable to each other by means of at least one permanent magnet. In some embodiments the plant tie comprises an attachment portion between the free ends, the attachment portion being adapted to attach the plant tie to a cylindrical member.

The present invention relates to plant ties.

Plant ties are used by gardeners to hold plants in certain positions whilst growing, thereby allowing the propagation of plants in desired manners.

Conventional plant ties have various drawbacks, generally requiring a high degree of dexterity to position, and also requiring significant work to remove when the plant tie is no longer required.

Furthermore, if a conventional plant tie is overlooked or forgotten and not adjusted as the plant grows it can damage the plant by restricting growth and cutting in to delicate stems.

The present invention seeks to address these issues and also seeks to provide hitherto unavailable functionality.

According to a first aspect of the present invention there is provided a plant tie comprising a plastically deformable elongate body having first and second free ends that are attachable to each other by means of at least one permanent magnet.

A plant tie a plastically deformable elongate body having free ends that are connectable by magnetism has multiple benefits. The use of magnet to connect free ends means that they may be readily deployed and removed even by persons with diminished dexterity, such as the elderly. Further by the providing magnets of appropriate strength plant damage by plant ties that have been forgotten about does not occur as the plant is able to break the magnetic connection and avert damage to the stem or other parts of the plant. Further, the provision of a plastically deformable elongate body means that the plant tie may be used to secure plants in desired configurations without joining the free ends of the plant tie together. Indeed, a section of the plastically deformable member may be employed to attach the pant tie to a stake, or plant by coiling the member around it. Even further, in embodiments where both free ends comprise a permanent magnet and when used with metal poles, the free ends of the plant tie may be separately attached to different parts of the. Even further, multiple plant ties may be magnetically joined to each other so as to create a chain of a plurality of plant ties.

In some embodiments the plant tie comprises a permanent magnet adjacent the first free end and a magnetic material adjacent the second free end.

In some embodiments the plant tie comprises a permanent magnet adjacent the first free end and a permanent magnet adjacent the second free end.

In some embodiments the plastically deformable elongate body is provided by at least one portion of plastically deformable metal wire.

Preferably the plastically deformable wire is at least part covered in a plastics material.

Preferably the plastically deformable wire is fully covered in a plastics material.

In some embodiments the plant tie comprises an attachment portion between the free ends, the attachment portion being adapted to attach the plant tie to a substantially cylindrical member.

Preferably the attachment portion comprises a recess that is adapted to releasably clip the plant tie to a substantially cylindrical member.

Preferably the recess is at least part substantially cylindrical.

Preferably the attachment portion is substantially equidistantly disposed between the first and second free ends.

In some embodiments a magnet is contained in a plastic housing.

In some embodiments there is provided a kit comprising a plant tie made in accordance with any preceding statement of invention, the kit further comprising at least one metal pole.

Preferably the kit comprises a plurality of metal poles.

According to a second aspect of the present invention there is provided a method of retaining a plant in a selected position comprising the steps of:
providing a plant tie made in accordance with any preceding statement of invention;
retaining a plant with the plant tie.

In some embodiments the method further comprises the steps of:
providing at least one metal pole; and
attaching the plant tie to the metal pole by the attachment portion.

In some embodiments the method further comprises the step of attaching the plant tie to the metal pole by a first magnet at a first free end of the plant tie and attaching the plant tie to the metal pole by a second magnet at a second free end of the plant tie.

In some embodiments the method further comprises the step of attaching to each other the first and second free ends of the plant tie.

In some embodiments the plant tie comprises an attachment portion between the free ends, the attachment portion being adapted to attach the plant tie to a cylindrical member and the method further comprises the step of attaching the plant tie to substantially cylindrical member with the attachment portion.

In order that the invention may be more fully understood specific embodiments will now be described with reference to the accompanying drawings, of which:

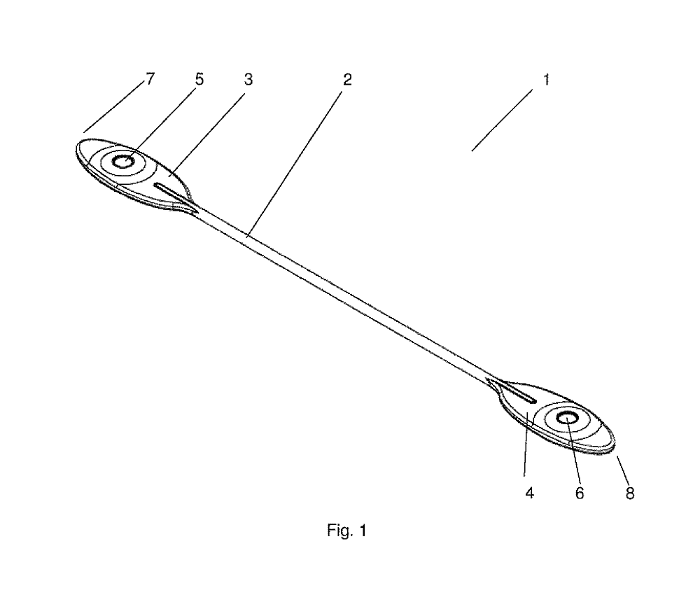

FIG. 1 is a perspective view of a plant tie made in accordance with a first embodiment of the present invention;

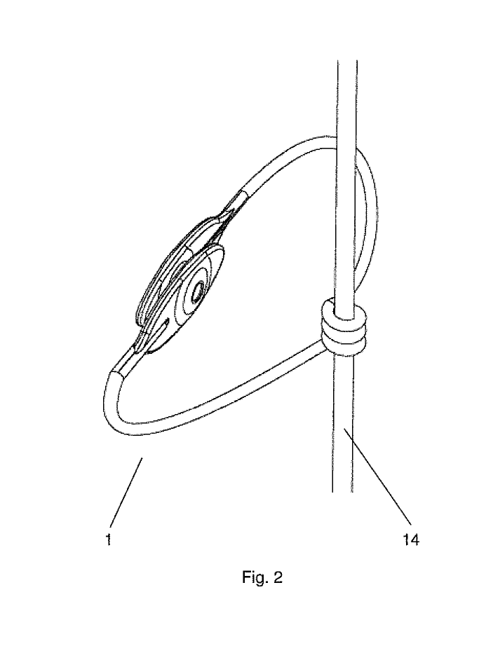

FIG. 2 is a perspective view of the plant tie of FIG. 1 attached to a cane and with its magnets attached to each other;

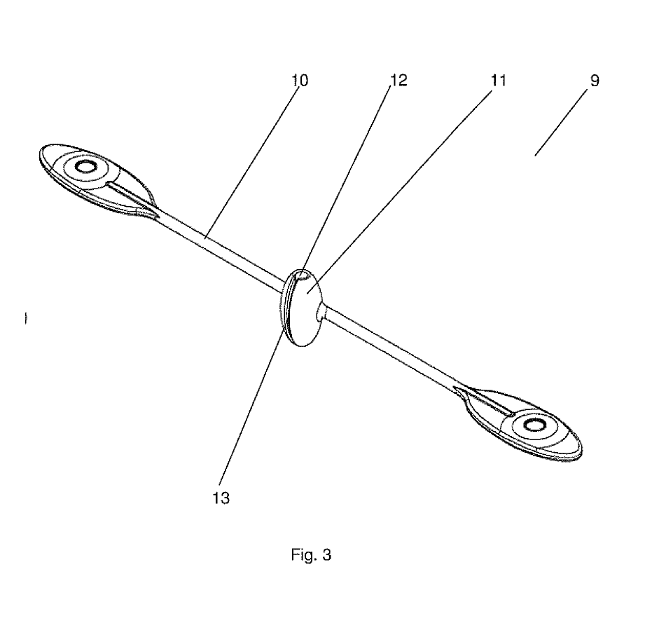

FIG. 3 is a perspective view of a plant tie made in accordance with a second embodiment of the present invention;

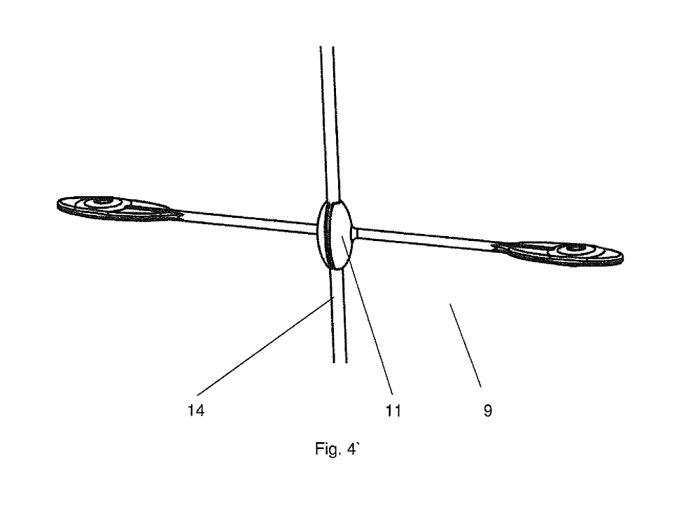

FIG. 4 is a perspective view of the plant tie of FIG. 3 attached to a garden cane.

Referring to FIG. 1, a flexible elongate plant tie 1 comprises a central flexible elongate member 2 extending between first magnet housing 3 and second magnet housing 4.

Flexible elongate member 2 is formed of a metal wire covered in a moulded elastomeric plastics material in order to protect the wire from weather damage.

First magnet housing 3 is a substantially planar oval tab that is formed of a plastics material and houses first magnet 5 adjacent first free end 7 of plant tie 1.

Similarly second magnet housing 4 is a substantially planar oval tab that is formed of a plastics material and houses second magnet 6 adjacent second free end 8 of plant tie 1.

First and second magnets 5, 6 are neodymium magnets of 8 mm diameter and 3 mm thickness.

The total length of plant tie 1 from free end 7 to free end 8 is around 30 cm, but it will be appreciated that any suitable length of plant tie might be provided.

Turning to plant tie 1 in use and referring to FIG. 2, flexible elongate member 2 may be deformed by a user such that magnets 5, 6 attract to each other and thereby hold magnet housings 3, 4 touching each other. As can be seen from FIG. 2 plant tie 1 may be wound around a garden cane 14 so as to attach it thereto by means of flexible elongate member 2.

Thus when appropriately positioned by a user plant tie 1 operates to retain a plant in a desired position.

Owing to the magnetic attraction between magnets 5, 6 plant tie 1 is readily and easily positionable. This is in contrast to prior art plant ties that require twisting or knots to be tied.

Furthermore, plant tie 1 is readily removable by a user simply by pulling magnets 5, 6 apart. Even further, when magnets 5, 6 are of an appropriate strength as a plant grows it is able to break apart magnets 5, 6 so as to avoid plant damage.

Advantageously plant tie 1 may be used with metal canes that are staked out in the same manner as normal bamboo garden canes. By attaching both of magnets 5, 6 to different parts of a metal cane a plant may be retained between plant tie 1 and the metal cane.

Turning to a second embodiment of the present invention and FIGS. 3 and 4, a plant tie 9 is substantially identical to plant tie 1 except that located substantially in the centre of elongate member 10 is found attachment portion 11.

Attachment portion 11 is substantially ovoid in shape and comprises a centrally disposed cylindrical recess 12 that is substantially orthogonal to elongate member 10 when elongate member is fully extended in a linear fashion as shown in FIG. 3.

Attachment portion 11 comprises an opening 13 down one side of cylindrical recess 12.

Attachment portion 11 is formed of an elastomeric plastics material that is able to flex opposite opening 13 so as to allow opening 13 to widen when force is applied and narrow under the material's natural restoring force.

Referring to FIG. 4 it can be seen that cylindrical recess 12 is of a size so as to snugly house a garden cane 14 therein.

In use, in order to clip plant tie 1 on to garden cane 14 a user simply presses cane 14 against opening 13 of attachment portion 11, which deforms so as to allow cane 14 to be pressed through opening 13 into cylindrical recess 12.

Once complete plant tie 9 remains in a substantially fixed position on cane 14 owing to the wall of cylindrical recess 12 gripping cane 14.

Plant tie 9 may then be used to releasably retain a plant on cane 14.

Although in the present embodiments substantially elongate linear plant ties are disclosed, in other embodiments various shapes and configurations of magnetic plant ties might be provided.

Although in the present embodiments two permanent magnets are housed in each plant tie, with a magnet adjacent respective free ends of the plant ties it will be apparent that in other embodiments only a single magnet might be provided adjacent a first free end of a plant tie, and at the other end a metal material that is attracted to magnets, thus typically a ferrous material, may be provided adjacent a second free end of the plant tie.

Although such embodiments comprising a single magnet would operate as standalone plant ties such embodiments would not operate successfully with metal canes as only one end of the plant tie would attach to the cane.

In other embodiments a plurality of magnets greater than two might be provided. In such embodiments a plurality of free ends greater than two might each comprise respective magnets. Such plant ties may be in the form of crosses, stars or other shapes.

In some embodiments the length of the plant tie when fully extended is between 10 cm and 50 cm, but may more preferably be between 20 cm and 40 cm and even more preferably be between 25 cm and 35 cm.

It should be apparent that throughout this patent specification the term ‘magnetic’ is intended to refer to something that is already magnetized and not merely to a substance that might be attracted to a magnet.

Many variations are possible without departing from the scope of the present invention as set out in the appended claims.

1. A plant tie comprising a plastically deformable elongate body having first and second free ends that are attachable to each other by means of at least one permanent magnet.

2. The plant tie of claim 1 comprising a permanent magnet adjacent the first free end and a magnetic material adjacent the second free end.

3. The plant tie of claim 1 comprising a permanent magnet adjacent the first free end and a permanent magnet adjacent the second free end.

4. The plant tie of any preceding claim wherein the plastically deformable elongate body is provided by at least one portion of plastically deformable metal wire.

5. The plant tie of claim 4 wherein the plastically deformable wire is at least part covered in a plastics material.

6. The plant tie of claim 4 wherein the plastically deformable wire is fully covered in a plastics material.

7. The plant tie of any preceding claim comprising an attachment portion between the free ends, the attachment portion being adapted to attach the plant tie to a substantially cylindrical member.

8. The plant tie of claim 7 wherein the attachment portion comprises a recess that is adapted to releasably clip the plant tie to a substantially cylindrical member.

9. The plant tie of claim 8 wherein the recess is at least part substantially cylindrical.

10. The plant tie of any of claims 7 to 9 wherein the attachment portion is substantially equidistantly disposed between the first and second free ends.

11. The plant tie of any preceding claim wherein a magnet is contained in a plastic housing.

12. A kit comprising a plant tie made in accordance with any preceding claim, the kit further comprising at least one metal pole.

13. The kit of claim 12 comprising a plurality of metal poles.

14. A method of retaining a plant in a selected position comprising the steps of:
providing a plant tie made in accordance with any preceding statement of invention;
retaining a plant with the plant tie.

15. The method of claim 14 further comprising the steps of:
providing at least one metal pole; and
attaching the plant tie to the metal pole by a first magnet at a first free end of the plant tie.

16. The method of claim 15 further comprising the step of attaching the plant tie to the metal pole by a second magnet at a second free end of the plant tie.

17. The method of claim 14 further comprising the step of attaching to each other the first and second free ends of the plant tie.

18. The method of any of claims 14 to 17 wherein the plant tie comprises an attachment portion between the free ends, the attachment portion being adapted to attach the plant tie to a cylindrical member and the method further comprises the step of attaching the plant tie to substantially cylindrical member with the attachment portion.

19. A plant tie substantially as described herein with reference to the accompanying drawings.
